(19) United States
(12) Patent Application Publication
(10) Pub. No.: US 2026/0055881 A1
(43) Pub. Date: Feb. 26, 2026

(54) LAMP HOLDER, MANUFACTURING METHOD THEREOF, LAMP AND ASSEMBLING METHOD THEREOF

(71) Applicants: Solar Nation PowerTech Enterprises Company Limited, Guangzhou (CN); Dongguan Honghai Optoelectronics Technology Co., Ltd., Dongguan (CN)

(72) Inventors: BO TAN, Guangzhou (CN); LING QIN, DONGGUAN (CN)

(21) Appl. No.: 19/373,594

(22) Filed: Oct. 29, 2025

(30) Foreign Application Priority Data
Aug. 25, 2025 (CN) 2025111951174

(51) Int. Cl. F21V 23/00; F21V 17/06; F21V 23/06; F21V 31/00

(52) U.S. Cl. CPC F21V 23/002; F21V 17/06; F21V 23/06; F21V 31/005

(57) ABSTRACT

A lamp holder includes a base body, a cover, and a conductor contact. The base body has a first end and a second end opposite to each other, and is provided with a mounting slot extending along a first direction from the first end towards the second end. The cover is detachably connected to the first end of the base body, wherein the cover and the base body are configured to accommodate a wire therebetween. The conductor contact is disposed within the mounting slot and electrically connected to the wire. A limiting structure is provided on at least one of the base body or the conductor contact, configured to restrict movement of the conductor contact relative to the base body along the first direction.

### CROSS-REFERENCE TO RELATED APPLICATIONS

This application claims priority to Chinese patent application No. 2025111951174, filed on Aug. 25, 2025, which is hereby incorporated by reference in its entirety.

### TECHNICAL FIELD

The present disclosure relates to the field of lighting devices, and in particular to a lamp holder, a manufacturing method thereof, a lamp and an assembling method thereof.

### BACKGROUND

Lighting devices include various lamps, which are widely used in people's lives and production.

In some instances, a lamp includes a lamp holder and a light source. The lamp holder is connected to a wire, and the light source is installed on the lamp holder to achieve electrical connection between the light source and the wire. The reliability of the lamp holder directly determines the reliability of the connection between the light source and the wire, thereby affecting the reliability of the lamp. Therefore, how to improve the reliability of the lamp holder is a technical problem that needs to be solved urgently.

### SUMMARY

According to an aspect of some embodiments of the present disclosure there is provided a lamp holder, including a base body, a cover, and a conductor contact.

The base body has a first end and a second end opposite to each other. The base body is provided with a mounting slot extending along a first direction, the first direction being a direction from the first end to the second end.

The cover is detachably connected to the first end of the base body. The cover and the base body are configured to accommodate a wire therebetween.

The conductor contact is disposed within the mounting slot and electrically connected to the wire.

At least one of the base body or the conductor contact is provided with a limiting structure, the limiting structure being configured to restrict movement of the conductor contact relative to the base body along the first direction.

In some embodiments, along the first direction, a cross-sectional dimension of the mounting slot gradually decreases, and a cross-sectional dimension of the conductor contact is greater than a minimum cross-sectional dimension of the mounting slot.

The limiting structure is configured as an inner surface of the mounting slot.

In some embodiments, the limiting structure is configured as a first limiting block provided at the second end of the base body.

Along the first direction, a projection of the first limiting block at least partially overlaps with a projection of the mounting slot.

An end of the conductor contact facing the second end of the base body is configured to abut against the first limiting block.

In some embodiments, the limiting structure is configured as a second limiting block provided on the conductor contact, the second limiting block being located on a side of the conductor contact facing the first end of the base body.

The second limiting block is configured to abut against an end face of the first end of the base body.

In some embodiments, the first end of the base body is provided with an accommodation slot, the accommodation slot being configured to accommodate the wire.

An end of the conductor contact facing the first end of the base body is tapered, and at least a portion of the end of the conductor contact is located within the accommodation slot.

According to an aspect of some embodiments of the present disclosure there is provided a method for manufacturing the lamp holder as described in any of the above embodiments, including:
Providing a base body mold;
Fixing the conductor contact within the base body mold; and
Obtaining the base body by injecting plastic into the base body mold.

According to an aspect of some embodiments of the present disclosure there is provided a lamp, including:
The lamp holder as described in any of the above embodiments;
A lampshade detachably connected to the lamp holder; and
A light source, at least a portion of which is located within the lampshade.

The light source is electrically connected to the conductor contact.

According to an aspect of some embodiments of the present disclosure there is provided a method for assembling the lamp as described in any of the above embodiments, including:
Assembling the conductor contact to the base body;
Assembling the wire into the accommodation slot and electrically connecting the wire to the conductor contact;
Connecting the cover to the base body;
Assembling the light source into an assembly hole and electrically connecting the light source to the conductor contact; and
Connecting the lampshade to the base body.

In some embodiments, the assembling the wire into the accommodation slot and electrically connecting the wire to the conductor contact includes:

Piercing an end of the conductor contact into the wire to electrically connect the wire and the conductor contact.

In some embodiments, the method further including:

Performing at least one of a first sealing operation, a second sealing operation, and a third sealing operation.

The first sealing operation includes: dispensing glue at an end of the conductor contact connected to the wire.

The second sealing operation includes: performing an overmolding process on the base body and the cover.

The third sealing operation includes: dispensing glue at a connection portion between the lampshade and the base body.

### BRIEF DESCRIPTION OF DRAWINGS

In the accompanying drawings, unless otherwise specified, the same reference numerals throughout the multiple drawings represent the same or similar components or elements. These drawings are not necessarily drawn to scale. It should be understood that these drawings merely depict some implementations according to the present disclosure and should not be considered as limiting the scope of the present disclosure.

FIG. 1 is a first schematic structural view of a lamp holder according to some embodiments of the present disclosure.

FIG. 2 is a second schematic structural view of the lamp holder according to some embodiments of the present disclosure.

FIG. 3 is a cross-sectional schematic structural view of the lamp holder according to some embodiments of the present disclosure.

FIG. 4 is a third schematic structural view of the lamp holder according to some embodiments of the present disclosure.

FIG. 5 is a schematic structural view of a base body and a conductor contact according to some embodiments of the present disclosure.

FIG. 6 is a partial schematic structural view of a lamp according to some embodiments of the present disclosure.

FIG. 7 is a schematic structural view of a lamp according to some embodiments of the present disclosure.

FIG. 8 is a flowchart of a method for assembling a lamp according to some embodiments of the present disclosure.

### DETAILED DESCRIPTION OF THE EMBODIMENTS

The following will provide a clear and complete description of the technical solutions of the embodiments of the present disclosure. It is clear that the described embodiments are only part of the embodiments of the present disclosure, not all of them. All other embodiments obtained by those skilled in the art without inventive effort based on the embodiments of the present disclosure fall within the protection scope of the present disclosure.

The singular forms “a/an” and “the” as used in the specification, unless clearly indicated, all contain the plural forms. The words “comprising”, “containing” and “including” used in the specification indicate the presence of the claimed features, but do not preclude the presence of one or more additional features. The wording “and/or” as used in the specification includes any and all combinations of one or more of the items listed.

In the description of the embodiments of the present disclosure, the technical terms “first”, “second”, etc., are used only to distinguish different objects and should not be understood as indicating or implying relative importance or implicitly specifying the quantity, specific order, or primary-secondary relationship of the indicated technical features.

Mentioning “an embodiment” herein means that a particular feature, structure, or characteristic described in connection with the embodiment may be included in at least one embodiment of the present disclosure. The appearance of this phrase in various places in the specification does not necessarily refer to the same embodiment, nor is it an independent or alternative embodiment mutually exclusive with other embodiments. Those skilled in the art will understand explicitly and implicitly that the embodiments described herein can be combined with other embodiments.

In the description of the embodiments of the present disclosure, the term “a plurality of” refers to two or more (including two). Similarly, “a plurality of groups” refers to two or more groups (including two groups), and “a plurality of pieces” refers to two or more pieces (including two pieces).

In the description of the embodiments of the present disclosure, the orientation or positional relationship indicated by technical terms such as “center”, “longitudinal”, “transverse”, “length”, “width”, “thickness”, “up”, “down”, “front”, “back”, “left”, “right”, “vertical”, “horizontal”, “top”, “bottom” “inside”, “outside”, “clockwise”, “counterclockwise”, “axial”, “radial”, “circumferential”, etc., is based on the orientation or positional relationship shown in the accompanying drawings. These terms are used only for facilitating the description of the embodiments of the present disclosure and simplifying the description, and do not indicate or imply that the referred apparatus or element must have a specific orientation, be constructed and operated in a specific orientation. Therefore, they should not be construed as limiting the embodiments of the present disclosure.

In the description of the embodiments of the present disclosure, unless expressly specified or limited otherwise, the technical terms “mounted”, “connected”, “coupled”, “fixed” and the like should be interpreted broadly. For example, it may be a fixed connection or a detachable connection, or integrated into one; it may be a mechanical connection or an electrical connection; it may be a direct connection or an indirect connection through an intermediary, and it may be an internal communication between two elements or an interaction relationship between two elements. Those of ordinary skill in the art can understand the specific meanings of these terms in the embodiments of the present disclosure according to specific situations.

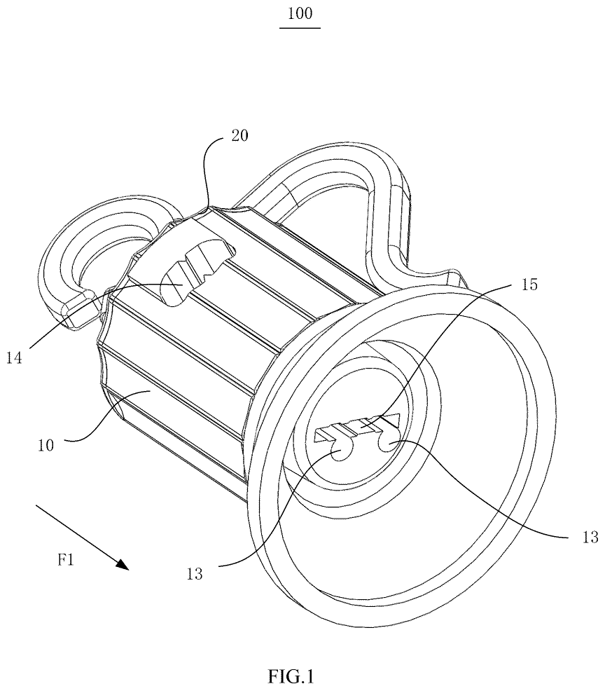

Some embodiments of the present disclosure provide a lamp holder 100, as shown in FIGS. 1-5, including a base body 10, a cover 20, and a conductor contact 30.

The base body 10 has a first end 11 and a second end 12 opposite to each other. The base body 10 is provided with a mounting slot 13 extending along a first direction F1, the first direction F1 being a direction from the first end 11 to the second end 12. The cover 20 is detachably connected to the first end 11 of the base body 10. The cover 20 and the base body 10 are configured to accommodate a wire 400 therebetween. The conductor contact 30 is disposed within the mounting slot 13 and electrically connected to the wire 400.

At least one of the base body 10 or the conductor contact 30 is provided with a limiting structure 40, the limiting structure 40 being configured to restrict movement of the conductor contact 30 relative to the base body 10 along the first direction F1.

The base body 10 is a component for securing a light source 200 and the wire 400. The mounting slot 13 is a slot structure for arranging the conductor contact 30, thereby being capable of reducing movement of the conductor contact 30.

The cover 20 is a component that cooperates with the base body 10 to tightly connect the wire 400 to the base body 10, thereby ensuring reliable electrical connection between the wire 400 and the conductor contact 30.

The conductor contact 30 is a component for achieving electrical connection between the light source 200 and the wire 400, so that electric power is transmitted to the light source 200. The material of the conductor contact 30 may be metal.

The limiting structure 40 is a component that restricts the movement of the conductor contact 30 relative to the base body 10 along the first direction F1. When the cover 20 is assembled to the base body 10, it applies a force along the first direction F1 to the wire 400 and the conductor contact 30, causing the conductor contact 30 to have a tendency to move relative to the base body 10 along the first direction F1. This may lead to misalignment of the conductor contact 30, or even risk of disengagement from the mounting slot 13. By providing the limiting structure 40 to restrict the movement of the conductor contact 30, the accuracy of the relative position of the conductor contact 30 is ensured, thereby ensuring the reliability of the connection between the light source 200 and the conductor contact 30.

At least one of the base body 10 or the conductor contact 30 is provided with a limiting structure 40. It can be understood that the limiting structure 40 is provided on the base body 10, or the limiting structure 40 is provided on the conductor contact 30, or the limiting structure 40 is provided on both the base body 10 and the conductor contact 30.

By providing the limiting structure 40, the limiting function for the conductor contact 30 is achieved, which prevents the conductor contact 30 from being displaced due to squeezing by the cover 20 during assembly, ensuring the accuracy of the relative position between the conductor contact 30 and the base body 10, thereby improving the reliability of the entire lamp holder 100. Consequently, the reliability of the connection between the conductor contact 30 and the light source 200 is enhanced, thus improving the overall reliability of the lamp 1000.

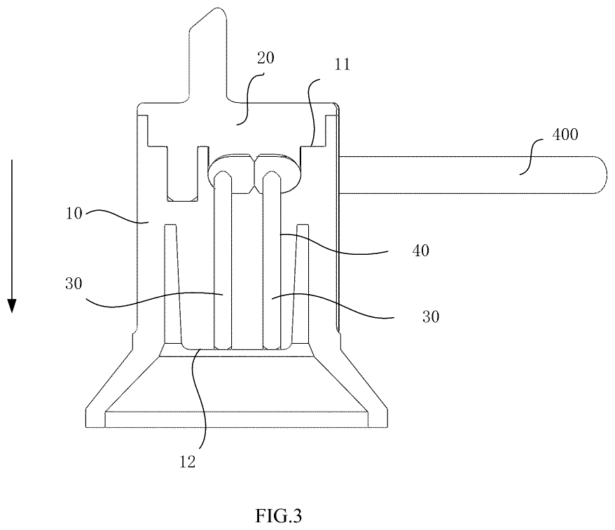

As shown in FIG. 3, in some embodiments, along the first direction F1, a cross-sectional dimension of the mounting slot 13 gradually decreases, and a cross-sectional dimension of the conductor contact 30 is greater than a minimum cross-sectional dimension of the mounting slot 13. The limiting structure 40 is configured as an inner surface of the mounting slot 13.

Along the first direction F1, the cross-sectional dimension of the mounting slot 13 gradually decreases. With reference to FIG. 3, it can be understood that the mounting slot 13 has a structure that is larger at the top and smaller at the bottom. Furthermore, the cross-sectional dimension of the conductor contact 30 is greater than the minimum cross-sectional dimension of the mounting slot 13, so that the conductor contact 30 cannot disengage from the mounting slot 13 along the first direction F1. A portion of the conductor contact 30 near the second end 12 of the base body 10 and the inner surface of the mounting slot 13 are in an interference fit, further enhancing the tightness of the connection between the conductor contact 30 and the mounting slot 13. The mounting slot 13 on the base body 10 forms the limiting structure 40 through its own gradually varying dimension structure, thereby preventing misalignment of the conductor contact 30.

By providing the mounting slot 13 with a gradually varying cross-sectional dimension, the limiting function for the conductor contact 30 is achieved. The structure is relatively simple, and accordingly, the manufacturing process is also relatively simple.

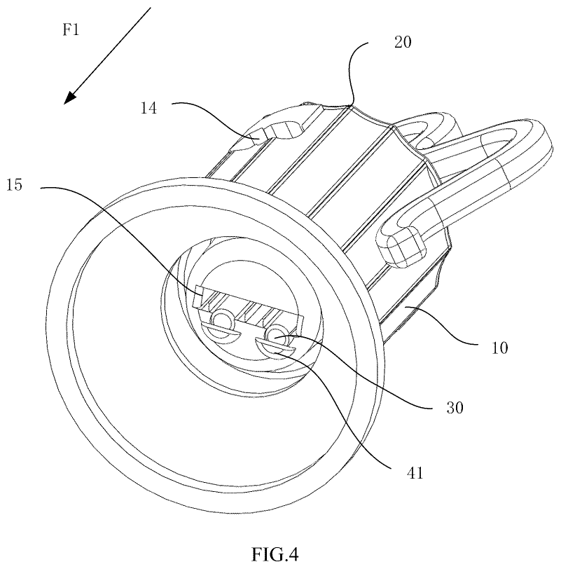

As shown in FIG. 4, in some embodiments, the limiting structure 40 is configured as a first limiting block 41 provided at the second end 12 of the base body 10. Along the first direction F1, a projection of the first limiting block 41 at least partially overlaps with a projection of the mounting slot 13. An end of the conductor contact 30 facing the second end 12 of the base body 10 is configured to abut against the first limiting block 41.

Along the first direction F1, the projection of the first limiting block 41 at least partially overlaps with the projection of the mounting slot 13. It can be understood that the first limiting block 41 at least partially blocks the end of the mounting slot 13. Simultaneously, the end of the conductor contact 30 abuts against the first limiting block 41, thereby providing a stopping function for the conductor contact 30 to prevent the conductor contact 30 from sliding relative to the mounting slot 13 along the first direction F1, thus achieving the limiting function.

In some embodiments, the projection shape of the first limiting block 41 along the first direction F1 is semicircular.

By providing the first limiting block 41 at the second end 12 of the base body 10 to form the limiting structure 40, the limiting function for the conductor contact 30 is achieved.

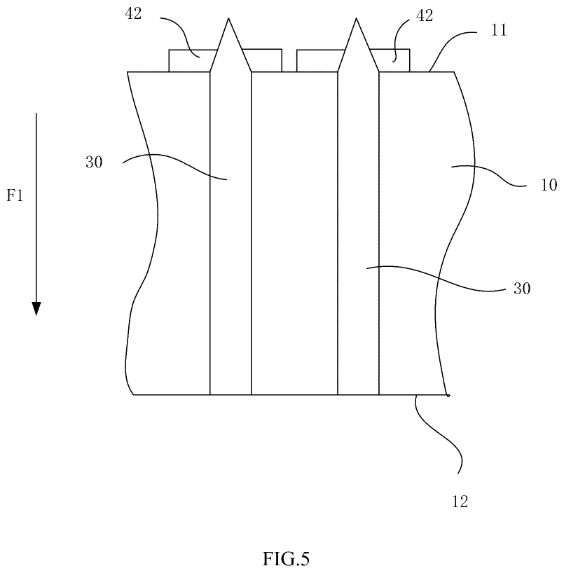

As shown in FIG. 5, in some embodiments, the limiting structure 40 is configured as a second limiting block 42 provided on the conductor contact 30. The second limiting block 42 is located on a side of the conductor contact 30 facing the first end 11 of the base body 10. The second limiting block 42 is configured to abut against an end face of the first end 11 of the base body 10.

The second limiting block 42 abuts against the end face of the first end 11 of the base body 10. Thereby, the second limiting block 42 provides a stopping function for the conductor contact 30 to prevent the conductor contact 30 from sliding relative to the mounting slot 13 along the first direction F1, thus achieving the limiting function.

By providing the second limiting block 42 on the conductor contact 30 to form the limiting structure 40, the limiting function for the conductor contact 30 is achieved.

In some embodiments, the first limiting block 41 and the second limiting block 42 are provided simultaneously to further enhance the reliability of limiting the conductor contact 30.

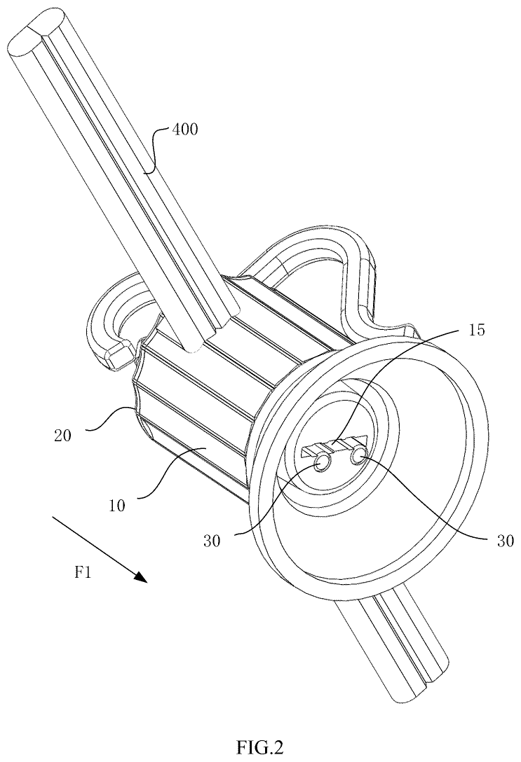

With reference to FIGS. 2 to 5, in some embodiments, the mounting slots 13 and the conductor contacts 30 are provided in a one-to-one correspondence, with two of each. One conductor contact 30 is configured as a positive contact, and the other conductor contact 30 is configured as a negative contact.

The two mounting slots 13 are spaced apart, thereby isolating the two conductor contacts 30 to prevent short circuits. The positive contact is used for contacting and connecting with a positive contact point of the light source 200, and the negative contact is used for contacting and connecting with a negative contact point of the light source 200. Correspondingly, two wires 400 are provided. The positive contact is electrically connected to the positive wire, and the negative contact is electrically connected to the negative wire. Thereby, normal operation of the lamp 1000 is achieved.

With reference to FIGS. 1 and 2, in some embodiments, the first end 11 of the base body 10 is provided with an accommodation slot 14, the accommodation slot 14 being configured to accommodate the wire 400.

The accommodation slot 14 provides a limiting function for the wire 400. In cooperation with the cover 20, the wire 400 can be clamped between the cover 20 and the base body 10 to reduce movement of the wire 400, further enhancing the reliability of the connection between the wire 400 and the conductor contact 30.

By providing the accommodation slot 14 to accommodate the wire 400, the overall reliability of the lamp 1000 is improved.

As shown in FIG. 3, in some embodiments, an end of the conductor contact 30 facing the first end 11 of the base body 10 is tapered, and at least a portion of the end of the conductor contact 30 is located within the accommodation slot 14.

At least a portion of the end of the conductor contact 30 is located within the accommodation slot 14, and the wire 400 is also arranged within the accommodation slot 14. Meanwhile, the end of the conductor contact 30 is tapered to facilitate piercing of the end into the wire 400, so that the conductor contact 30 fully contacts the wire 400, enhancing the reliability of the electrical connection between the conductor contact 30 and the wire 400.

By configuring the end of the conductor contact 30 to be tapered, the reliability of the electrical connection between the conductor contact 30 and the wire 400 is improved.

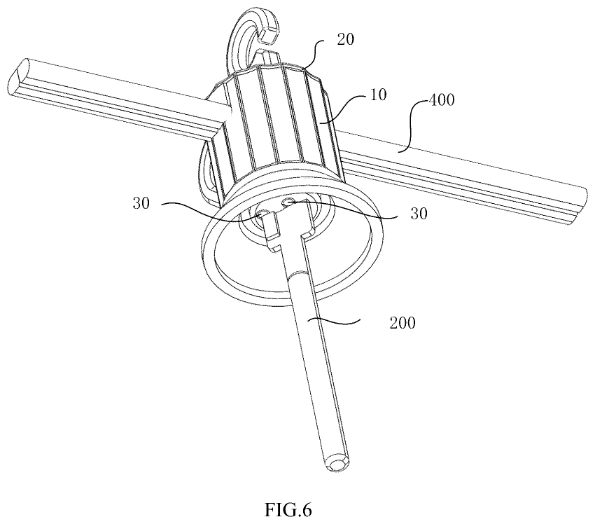

With reference to FIGS. 1, 2, 4, and 6, in some embodiments, the base body 10 is further provided with an assembly hole 15 for installing the light source 200. The assembly hole 15 is in communication with the mounting slot 13.

The assembly hole 15 is used for securing the light source 200. During assembly, an end of the light source 200 having contact points is inserted into the assembly hole 15. On one hand, this achieves a reliable connection between the light source 200 and the base body 10. On the other hand, since the assembly hole 15 is in communication with the mounting slot 13, the contact points on the light source 200 contact the conductor contact 30, thereby achieving electrical connection between the light source 200 and the conductor contact 30.

In some embodiments, the assembly hole 15 is located on a side of the mounting slot 13. Correspondingly, the contact points on the light source 200 are electrically connected to a side surface of the conductor contact 30.

Some embodiments of the present disclosure provide a method for manufacturing the lamp holder as described in any of the above embodiments, including:
Providing a base body mold;
Fixing the conductor contact within the base body mold; and
Obtaining the base body by injecting plastic into the base body mold.

When manufacturing the base body 10, it is obtained by injection molding using a base body mold. The conductor contact 30 is pre-fixed within the base body mold. Thereby, after the base body is injection molded, it forms an integrated structure with the conductor contact 30, simplifying the assembly steps between them. Simultaneously, the sealing between them is improved, enhancing waterproof performance.

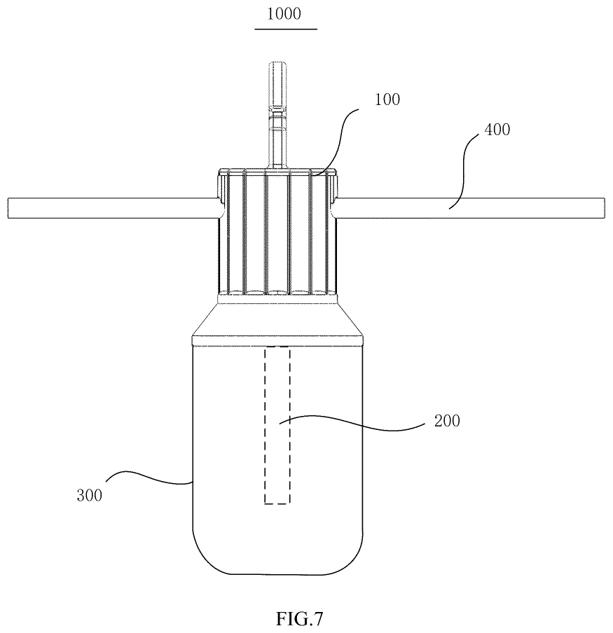

Some embodiments of the present disclosure provide a lamp 1000, as shown in FIG. 7, including: the lamp holder 100 as described in any of the above embodiments, a lampshade 300 and a light source 200. The lampshade 300 is detachably connected to the lamp holder 100. At least a portion of the light source 200 is located within the lampshade 300. The light source 200 is electrically connected to the conductor contact 30.

The lampshade 300 is sleeved over the light source 200, thereby protecting the light source 200. Meanwhile, the lampshade 300 is detachably connected to the lamp holder 100 to facilitate replacement of the light source 200.

In some embodiments, the assembly method between the lampshade 300 and the lamp holder 100 may be threaded connection or snap connection. When it is a snap connection, an inner bottom of the lamp holder 100 is provided with a snap groove. Correspondingly, an end of the lampshade 300 connected to the lamp holder 100 is provided with a protrusion structure. The protrusion structure and the snap groove cooperate to achieve snap connection between the lamp holder 100 and the lampshade 300.

The lamp 1000 in this embodiment have all the beneficial effects of the aforementioned lamp holder 100, which will not be repeated here.

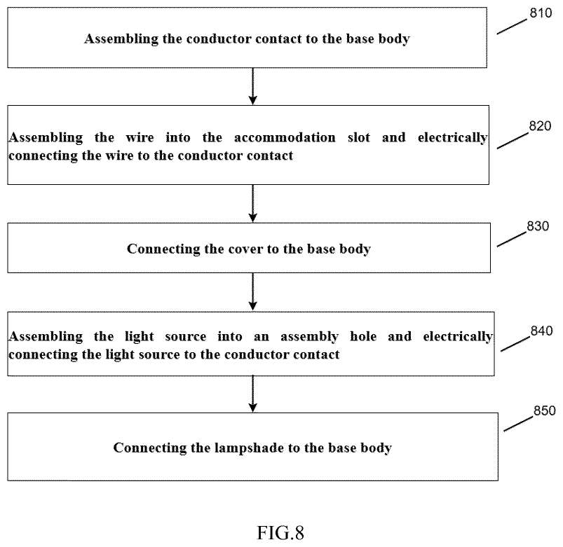

Some embodiments of the present disclosure provide a method for assembling the lamp as described in any of the above embodiments, as shown in FIG. 8, including step 810, step 820, step 830, step 840, and step 850.

Step 810: Assembling the conductor contact 30 to the base body 10.

In some embodiments, both the conductor contact 30 and the mounting slot 13 are provided in two numbers. The conductor contact 30 is placed into the corresponding mounting slot 13 along the first direction F1. Under the action of the limiting structure, after the conductor contact 30 is assembled in place, it cannot move relative to the base body 10 along the first direction F1.

In some embodiments, the base body 10 is integrally formed with the conductor contact 30 during injection molding, thereby achieving assembly between them.

Step 820: Assembling the wire 400 into the accommodation slot 14 and electrically connecting the wire 400 to the conductor contact 30.

In this step, both the wire 400 and the accommodation slot 14 are provided in two numbers. The wire 400 is placed into the corresponding accommodation slot 14, and the tapered end of the conductor contact 30 pierces into the wire 400 to achieve electrical connection between the conductor contact 30 and the wire 400.

Step 830: Connecting the cover 20 to the base body 10.

In this step, the cover 20 presses the wire 400 tightly against the base body 10, ensuring tight contact between the wire 400 and the conductor contact 30. Simultaneously, under the action of the limiting structure 40, the conductor contact 30 will not be pressed out of the mounting slot 13 by the cover 20.

Step 840: Assembling the light source 200 into the assembly hole 15 and electrically connecting the light source 200 to the conductor contact 30.

In this step, the light source 200 is inserted into the assembly hole 15, so that a positive contact point on the light source 200 contacts the positive conductor contact, and a negative contact point on the light source 200 contacts the negative conductor contact, thereby achieving electrical connection between the light source 200 and the wire 400.

Step 850: Connecting the lampshade 300 to the base body 10.

In this step, by connecting the lampshade 300 to the base body 10, the light source 200 is enclosed within the lampshade 300.

In some embodiments, the assembling method further includes: performing at least one of a first sealing operation, a second sealing operation, and a third sealing operation.

The first sealing operation includes: dispensing glue at the end of the conductor contact 30 connected to the wire 400. Specifically, glue is applied at the tapered end of the conductor contact 30 to enhance sealing and reduce the probability of water entering the lamp 1000.

The second sealing operation includes: performing an overmolding process on the base body 10 and the cover 20 to enhance sealing and reduce the probability of water entering the lamp 1000.

The third sealing operation includes: dispensing glue at a connection portion between the lampshade 300 and the base body 10 to enhance sealing and reduce the probability of water entering the lamp 1000.

Finally, it should be noted that: the above embodiments are only used to illustrate the technical solutions of the present disclosure, rather than limiting them. Although the present disclosure has been described in detail with reference to the foregoing embodiments, those of ordinary skill in the art should understand that they can still modify the technical solutions described in the foregoing embodiments, or perform equivalent substitutions for some or all of the technical features, without departing from the scope of the technical solutions of the embodiments of the present disclosure. These modifications or substitutions are intended to be included within the scope of the present disclosure as defined by the claims and the specification. In particular, as long as there is no structural conflict, the various technical features mentioned in the embodiments can be combined in any manner. The present disclosure is not limited to the specific embodiments disclosed herein but includes all technical solutions falling within the scope of the claims.

What is claimed is:

1. A lamp holder, comprising:
a base body having a first end and a second end opposite to each other, wherein the base body is provided with a mounting slot extending along a first direction, the first direction being a direction from the first end to the second end;
a cover detachably connected to the first end of the base body, wherein the cover and the base body are configured to accommodate a wire therebetween; and
a conductor contact disposed within the mounting slot and electrically connected to the wire;
wherein at least one of the base body or the conductor contact is provided with a limiting structure, the limiting structure being configured to restrict a movement of the conductor contact relative to the base body along the first direction.

2. The lamp holder according to claim 1, wherein along the first direction, a cross-sectional dimension of the mounting slot gradually decreases, and a cross-sectional dimension of the conductor contact is greater than a minimum cross-sectional dimension of the mounting slot, and wherein the limiting structure is configured as an inner surface of the mounting slot.

3. The lamp holder according to claim 1, wherein the limiting structure is configured as a first limiting block provided at the second end of the base body, wherein along the first direction, a projection of the first limiting block at least partially overlaps with a projection of the mounting slot, and wherein an end of the conductor contact facing the second end of the base body is configured to abut against the first limiting block.

4. The lamp holder according to claim 1, wherein the limiting structure is configured as a second limiting block provided on the conductor contact, the second limiting block being located on a side of the conductor contact facing the first end of the base body, and wherein the second limiting block is configured to abut against an end face of the first end of the base body.

5. The lamp holder according to claim 1, wherein the first end of the base body is provided with an accommodation slot, the accommodation slot being configured to accommodate the wire; and wherein an end of the conductor contact facing the first end of the base body is tapered, and at least a portion of the end of the conductor contact is located within the accommodation slot.

6. A method for manufacturing the lamp holder according to any one of claims 1 to 5, comprising:
providing a base body mold;
fixing the conductor contact within the base body mold; and
obtaining the base body by injecting plastic into the base body mold.

7. A lamp, comprising:
the lamp holder according to any one of claims 1 to 5;
a lampshade detachably connected to the lamp holder; and
a light source, at least a portion of which is located within the lampshade, wherein the light source is electrically connected to the conductor contact.

8. A method for assembling the lamp according to claim 7, comprising:
assembling the conductor contact to the base body;
assembling the wire into the accommodation slot and electrically connecting the wire to the conductor contact;
connecting the cover to the base body;
assembling the light source into an assembly hole and electrically connecting the light source to the conductor contact; and
connecting the lampshade to the base body.

9. The method according to claim 8, wherein the assembling the wire into the accommodation slot and electrically connecting the wire to the conductor contact comprises:
piercing an end of the conductor contact into the wire to electrically connect the wire and the conductor contact.
The method according to claim 8, further comprising:
performing at least one of a first sealing operation, a second sealing operation, and a third sealing operation;
wherein the first sealing operation comprises: dispensing glue at an end of the conductor contact connected to the wire;
wherein the second sealing operation comprises: performing an overmolding process on the base body and the cover; and
wherein the third sealing operation comprises: dispensing glue at a connection portion between the lampshade and the base body.
